(19) United States
(12) Patent Application Publication
(10) Pub. No.: US 2006/0268024 A1
(43) Pub. Date: Nov. 30, 2006

(54) Image forming apparatus and method of changing a relative position between a print medium and a print head

(76) Inventor: Karp-sik Youn, Hwaseong-si (KR)

Correspondence Address: STANZIONE & KIM, LLP, 919 18TH STREET, N.W., SUITE 440, WASHINGTON, DC, 20006, US

(21) Appl. No.: 11/290,592

(22) Filed: Dec. 1, 2005

(30) Foreign Application Priority Data
May 31, 2005 (KR) 2005-46061

(51) Int. Cl. B41J 29/38

(52) U.S. Cl. 347/5

(57) ABSTRACT

An image forming apparatus includes a plurality of nozzles to be used in a printing operation. The nozzles to be used are set according to a size of a print medium and a reference nozzle determined by a use frequency, and an image is formed using the set nozzles. The image forming apparatus includes a print head having the plurality of nozzles arranged in a widthwise direction of the print medium, a displacement unit to cause a change in relative position between the print medium and a print head, and a controller to control the displacement unit to reduce deviation in use frequency of the respective nozzles.

### CROSS-REFERENCE TO RELATED APPLICATIONS

This application claims the benefit of Korean Patent Application No. 2005-46061 filed on May 31, 2005 in the Korean Intellectual Property Office, the disclosure of which is incorporated herein by reference.

### BACKGROUND OF THE INVENTION

1. Field of the Invention

The present general inventive concept relates to an image forming apparatus, and in particular, to an apparatus to form an image using a page printing type of image forming apparatus, and method thereof.

2. Description of the Related Art

Image forming apparatuses that form an image by ejecting ink droplets may be generally classified into reciprocating line printing type and page printing type image forming apparatuses. In the reciprocating line printing type image forming apparatus (hereinafter, referred to as “line printing type apparatus”) an image is formed by reciprocating a print head for ejecting ink in a widthwise direction of a print medium. In the page printing type image forming apparatus (hereinafter, referred to as “page printing type image forming apparatus”) nozzles are arranged over a length corresponding to a width of the print medium to form the image on each line of the print medium all at once as the print medium is transferred.

The line printing type image forming apparatus forms the image on the print medium as the print head with plural nozzles provided at a bottom side thereof reciprocates in the widthwise direction of the print medium. Therefore, the plural nozzles are evenly used.

Whereas, the page printing type image forming apparatus has a plurality of head chips provided at the bottom side of the print head, in which the head chips are respectively formed with the nozzles arranged in the widthwise direction of the print medium. The nozzles are arranged over the length corresponding to a widthwise size of the print medium having the largest width size that can be printed by the image forming apparatus. Accordingly, unless the image is printed on the print medium having the widest size, some of the nozzles are not operated due to a frequency in use of the nozzles of the print head, thereby causing deviation in a life span of the nozzles. Consequently, due to the deviation in the life span among the nozzles, the life span of the print head or the image forming apparatus can be shortened.

### SUMMARY OF THE INVENTION

The present general inventive concept provides an image forming apparatus and a method of changing a relative position between a print medium and a print head. According to the present general inventive concept, a plurality of nozzles in a print head may be more evenly used so that a life span of the print head and the image forming apparatus can be extended.

Additional aspects and advantages of the present general inventive concept will be set forth in part in the description which follows and, in part, will be obvious from the description, or may be learned by practice of the general inventive concept.

The foregoing and/or other aspects of the general inventive concept may be achieved by providing an image forming apparatus including a print head having a plurality of nozzles arranged in the widthwise direction of the print medium, a displacement unit to cause a change in relative position between the print medium and the print head, and a controller to control the displacement unit so that deviation in a use frequency of the respective nozzles is reduced.

If the deviation in use frequency of the respective nozzles exceeds a predetermined value, the controller changes a current reference nozzle group of the nozzles to a new reference nozzle group of nozzles and controls the displacement unit so that the new reference nozzle group of nozzles can be used to print an image on a sheet of paper rather than the current reference nozzle group of nozzles. The deviation in use frequency of the plurality of nozzles may be calculated on the basis of the number of image-formed print media of respective types. However, it is also possible to calculate the deviation in use frequency of the plurality of nozzles on the basis of an amount of the printed images.

The displacement unit may include a cam member that contacts the print head, a first drive motor to drive the cam member, and an elastic member to move the print head against the cam member.

The image forming apparatus may further include a paper-feeding tray, on which the print medium is loaded, a pick-up unit to pick up the print medium loaded on the paper-feeding tray, and a transfer unit to transfer the print medium picked up by the pick-up unit toward the print head. The displacement unit may displace at least one of the print head and the print medium picked up by the pick-up unit, and may include a screw rotatably supported on the paper-feeding tray, and a second drive motor to drive the screw, where the pick-up unit is connected to the screw such that the pick-up unit is displaced along the length of the screw when the screw rotates.

The foregoing and/or other aspects of the general inventive concept may be achieved by providing a method of printing an image using an image forming apparatus which comprises a print head having a plurality of nozzles arranged in a direction transverse to a direction of transferring a print medium, the method including comparing inputted deviation and previously set reference deviation of the respective plurality of nozzles, and changing the respective nozzles to be used when the inputted deviation is larger than the previously set reference deviation.

Comparing the inputted deviation and previously set reference deviation of the plurality of nozzles may further include changing a reference nozzle group to a new reference nozzle group and changing a relative position between the print head and the print medium on the basis of the new reference nozzle.

The foregoing and/or other aspects of the general inventive concept may be achieved by providing an image forming apparatus including a print head having a first and second group of nozzles to be used to form an image on a print medium and a controller to control a relative position between the print head and the print medium to select one of the first and second groups of the nozzles to be used.

The foregoing and/or other aspects of the general inventive concept may be achieved by providing an image forming apparatus including a print head having a first nozzle having a first use frequency and a second nozzle having a second use frequency and a controller to select one of the first nozzle and the second nozzle to be used to form an image on a print medium according to at least one of the first use frequency and the second use frequency.

The foregoing and/or other aspects of the general inventive concept may be achieved by providing an image forming apparatus including a print head having a plurality of nozzles disposed along a widthwise direction of a print medium to form a full line image in the print medium without moving in the widthwise direction and a controller to adjust a relative position between the print head and the print medium in the widthwise direction so that one of first and second groups of the plurality of nozzles is disposed to form the full line image on the print medium.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view schematically illustrating an image forming apparatus according to an embodiment of the present general inventive concept;

FIG. 2 is a perspective view schematically illustrating the image forming apparatus of FIG. 1;

FIGS. 3A and 3B are front views illustrating a movement of a print head of the image forming apparatus of FIG. 1;

FIG. 4 is a block diagram illustrating the image forming apparatus of FIG. 1;

FIG. 5 is a flowchart illustrating a method of forming an image according to an embodiment of the present general inventive concept;

FIGS. 6A to 6C are views illustrating a change in a relative position between the print head of FIG. 1 and a print medium;

FIG. 7 is a perspective view schematically illustrating a portion of an image forming apparatus according to an embodiment of the present general inventive concept; and

FIGS. 8A to 8C are views illustrating a change in relative position between a print medium and a print head caused by a movement of a pick-up unit according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

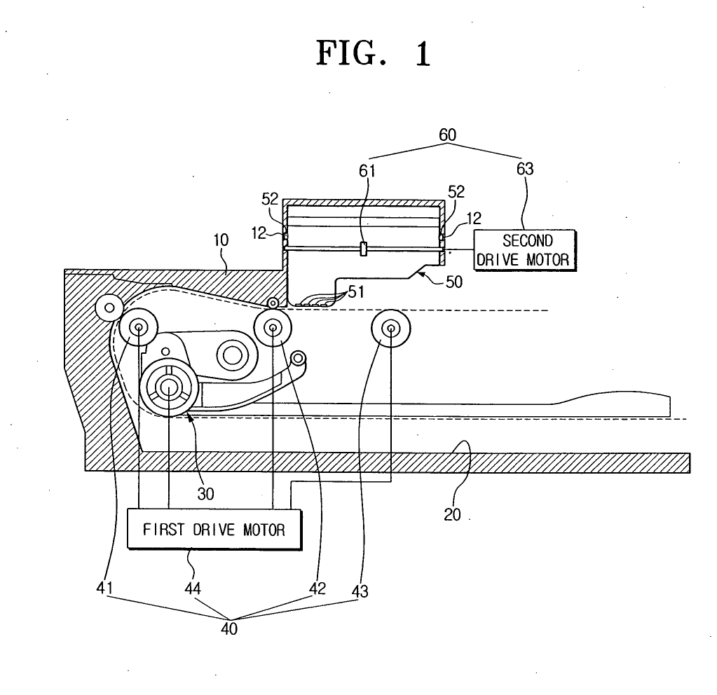

Referring to FIGS. 1 to 4, an image forming apparatus according to an embodiment of the present general inventive concept includes a main body 10, a paper-feeding tray 20, on which a print medium P to be fed is loaded, a pick-up unit 30 to pick up the print medium P loaded on the paper-feeding tray 20, a transfer unit 40 to transfer the print medium P picked up by the pick-up unit 30, a print head 50 to form an image on the print medium P transferred by the transfer unit 40, a displacement unit 60 to move the print head 50 in a direction transverse to a transferring direction of the print medium P, and a controller 70 to control the pick-up unit 30, the transfer unit 40, the print head 50 and the displacement unit 60.

The pick-up unit 30 is rotatably supported on the main body 10 and picks up the print medium P loaded on the paper-feeding tray 20 according to a signal transmitted from the controller 70.

The transfer unit 40 includes a drive roller 41 to transfer the print medium P picked up by the pick-up unit 30, a feeding roller 42 to feed the transferred print medium P below the print head 50, a discharge roller 43 to discharge the print medium with the image formed by the print head, and a first drive motor 44 to drive respective rollers 41, 42, and 43. The first drive motor 44 is connected to the controller 70 to communicate signals with the controller 70, and may be rotated according to a signal transmitted from the controller 70.

The print head 50 may contain, for example, inks of four colors, (i.e., yellow, magenta, cyan and black) and has four rows of head chips 51 arranged in a widthwise direction of the print medium P so that the inks of respective colors can be independently ejected.

The head chips 51 in each row are formed with nozzles disposed over a length corresponding to a width of a print medium P (i.e., a widest width that can be printed by the image forming apparatus). The widest print medium P is a letter-size paper, of which width is 216 mm. Therefore, the nozzles of the head chips 51 in each row are formed over a length of at least 216 mm in the widthwise direction of the print medium P. An A4 size paper, of which width is 203.2 mm, is also often used. When an image is formed on A4 size paper, only the nozzles corresponding to the width of 203.2 mm are used. Therefore, a frequency in use of the nozzles corresponding to the remaining 12.8 mm width (i.e., 216 mm−203.2 mm=12.8 mm) may be very low or none at all. For this reason, guide projections 52 are provided at the front and rear sides of the print head 50, and guide grooves 12 corresponding to the guide projections 52 are formed on the main body 10, so that the print head 50 can be displaced in the widthwise direction of the print medium P with respect to the main body 10.

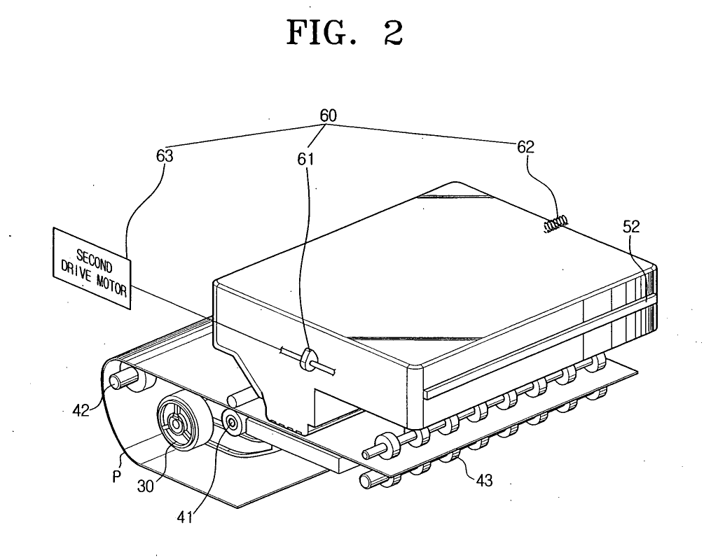

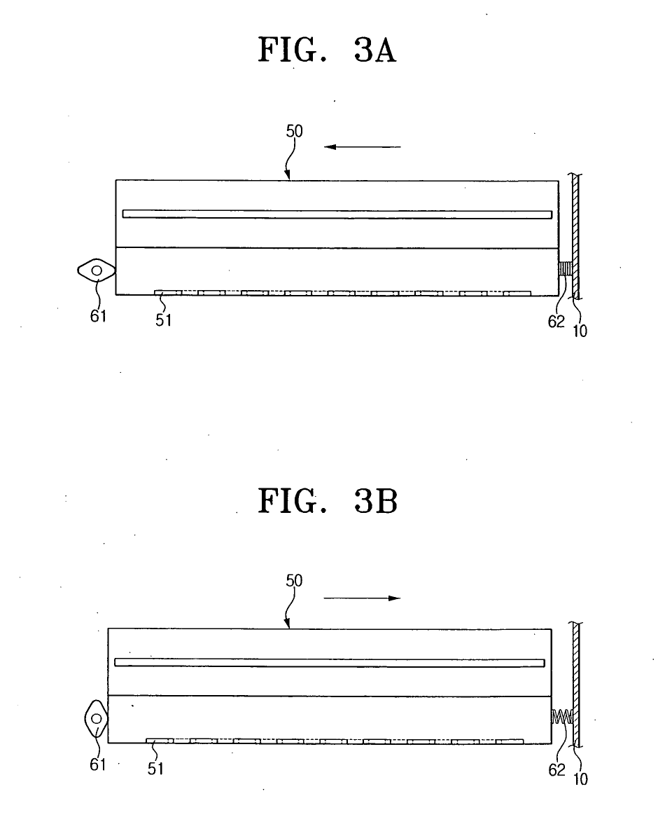

Referring to FIGS. 2, 3A and 3B, the displacement unit 60 includes a cam member 61, an elastic member 62 and a second driving motor 63 to displace the print head 60 in the widthwise direction of the print medium P to cause a change in relative position between the print head 50 and the print medium P in the widthwise direction of the print medium P.

Referring to FIG. 2, the cam member 61 comes into contact with one side of the print head 50 and is connected with the second drive motor 63 via a power transmission unit, such as one or more gear trains, to receive power from the second drive motor 63.

The elastic member 62 is interposed between the other side of the print head 50 and the main body 10 and moves the print head 50 against the cam member 61.

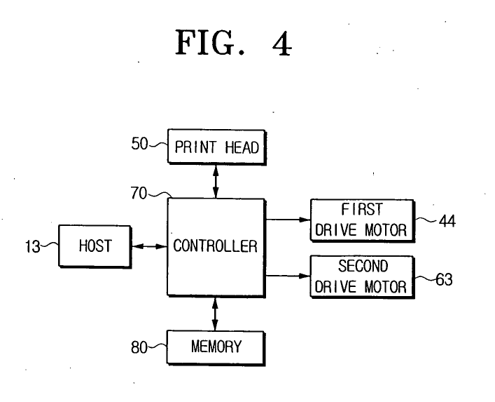

Referring to FIG. 4, the second drive motor 63 is connected with the controller 70 to communicate signals with the controller 70, and may be driven by one of the signals transmitted from the controller 70.

The controller 70 controls the first drive motor 44 to control each of the rollers 41, 42 and 43. The controller 70 processes print data transmitted from a host 13 into a print signal and transmits the print signal to the head chips 51 of the print head 50. In particular, the controller 70 may calculate deviation in use frequency of the nozzles, and if the calculated deviation is larger than a reference value, the controller 70 changes a current reference nozzle to a new reference nozzle to permit new nozzles to be used. The new reference nozzle may represent a group of any number of nozzles less than or equal to the total number of the nozzles. Once the new reference nozzle is set, the controller 70 controls the second drive motor 63 on the basis of the new reference nozzle to cause a change in relative position between the print head 50 and the print medium P in the widthwise direction of the print medium P. For example, if the nozzles include nozzles 1 through 10, the current reference nozzle group is nozzles 3-7, and the new reference nozzle group may be nozzles 1-5 or 6-10.

The memory 80 stores a program to drive the controller 70 and may be provided in the host 13, such as a computer other than the image forming apparatus. In particular, the memory 80 may store reference deviation in use frequency of the nozzles. Each reference nozzle may be determined according to a practical deviation in the use frequency of the nozzles. The deviation may be calculated by counting the number of times of ejecting ink through each nozzle, and the relative position between the print head 50 and the print medium P determined on the basis of the reference nozzle may be stored in the memory 80 in a form of a look-up table.

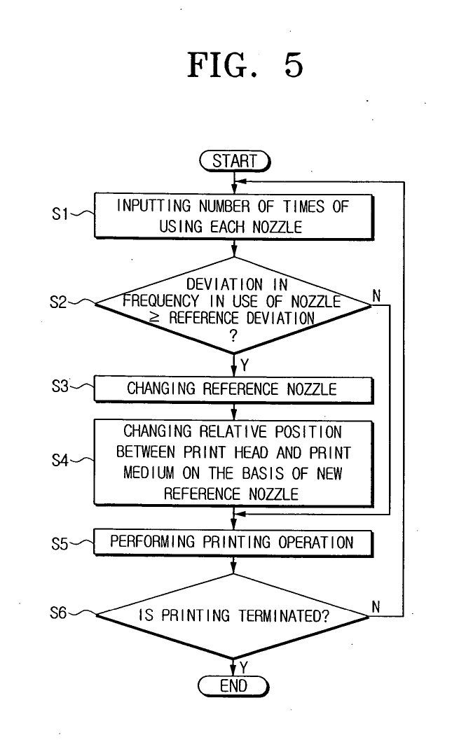

Now, a method of forming an image in the image forming apparatus according to an example embodiment of the present general inventive concept is described in detail with reference to FIG. 5.

Referring to FIGS. 4 and 5, the number of times of ejecting ink of each nozzle may be counted during repeated image forming processes (i.e. the number of times of using each nozzle), and may be stored in the controller 70 (S1). Then, the controller 70 calculates deviation in use frequency of respective nozzles on the basis of the number of times of using each nozzle, the data of which is provided from each nozzle. Although the calculation of the deviation in use frequency can be statistically made, it is possible to calculate the deviation by counting the number of printed pages of respective types of print media classified according to the sizes of the print media. It is also possible to calculate the deviation by using the pages of the printed print media (i.e. a printed amount, regardless of the size of the print medium P). This is because the types of print media P vary in different localities of the world when using image forming apparatuses. For example, as the print media, A4 size papers are usually used in some countries whereas letter-size papers are usually used in other countries.

If the practical deviation in use frequency of nozzles is calculated, it is compared with a reference deviation (S2). Although, a statistically calculated value can be used as the reference deviation, it is possible to use a value obtained by measuring the amount of printing.

If the practical deviation in use frequency of nozzles is larger than the reference deviation, the current reference nozzle group is changed to the new reference nozzle group to permit the new reference nozzle group to be used depending on the size of the print medium P (S3). The change of the reference nozzle group is performed to reduce the deviations in use frequency of the respective nozzles. Therefore, the current reference nozzle group is changed to the new reference nozzle group in such a manner that less used nozzle(s) can be more frequently used than the more used nozzles. The current reference nozzle group may be a first set of nozzles, and the new reference nozzle group may be a second set of nozzles. Some of the first set of nozzles may be identical to some of the second set of nozzles. It is possible that the nozzles having less use frequency can be included in the new reference nozzle group according to a size of the print medium P

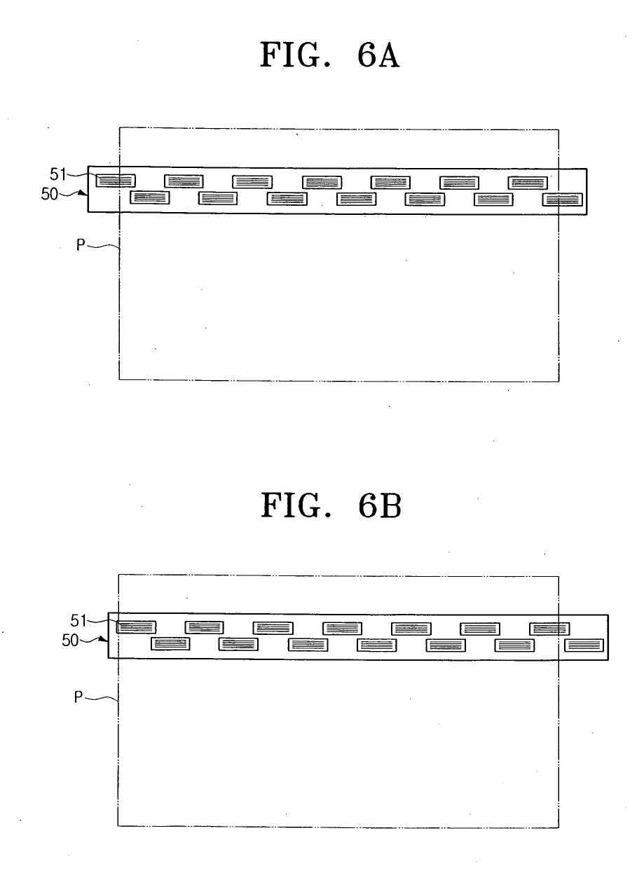

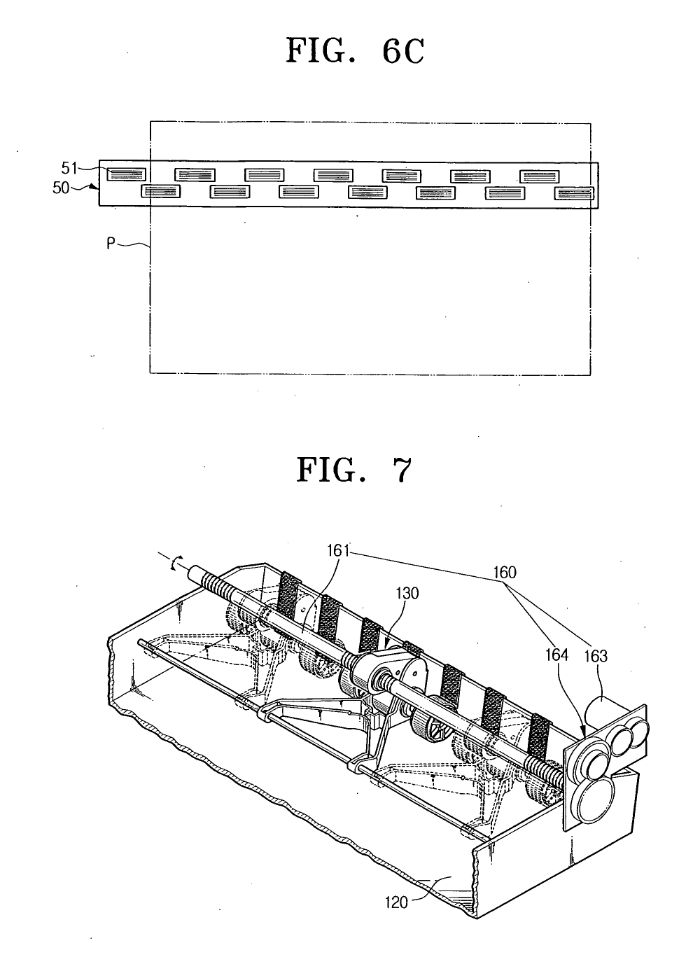

If the current reference nozzle group is changed to the new reference nozzle group, the change in relative position between the print head 50 and the print medium P is caused on the basis of the new reference nozzle (S4). In order to change the relative position, the controller 70 drives the second drive motor 63 to rotate the cam member 61. Then, the print head 50 is displaced in the widthwise direction of the print medium P due to the cooperation of the cam member 61 and the elastic member 62 as illustrated in FIGS. 3A and 3B. Then, a position of the head chips 51 of the print head 50 with respect to the print medium P is changed as illustrated in FIGS. 6A to 6C. Therefore, it is possible to use a nozzle which is low in use frequency, thus equalizing the life spans of respective nozzles and/or head chips 51. By equalizing the life spans of the respective nozzles or head chips 51, the life span of the print head 50 and the life span of the image forming apparatus can also be increased.

If the movement of the print head 50 is completed, the controller 70 outputs signals according to the print data transmitted from the host 13 to the respective nozzles of the head chips 51 provided in the print head 50, so that an image is formed and a printing operation is performed (S5). The controller 70 drives the transfer unit 40 so that the printing operation is performed when the print medium P is transferred below the print head 50.

After the printing operation has been performed, it is determined whether the printing is terminated (S6), and if the printing is not terminated, the operation of inputting the number of uses of each nozzle (S1) is performed again.

Meanwhile, if the deviation in use frequency of the respective nozzles is smaller than the reference deviation, the printing operation is performed without changing the relative position between the print head 50 and the print medium P (S5).

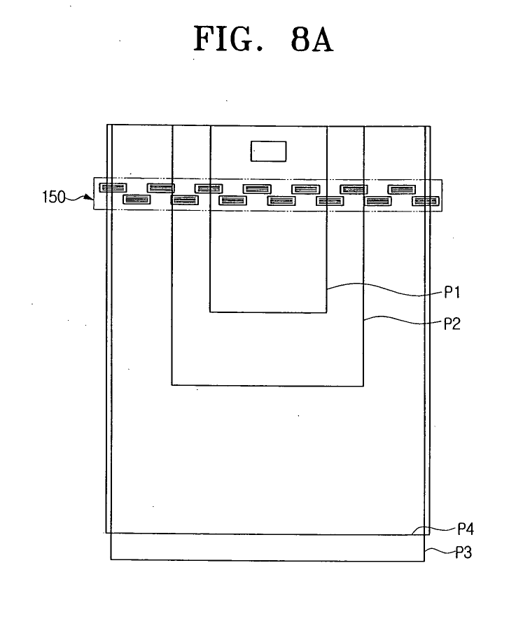

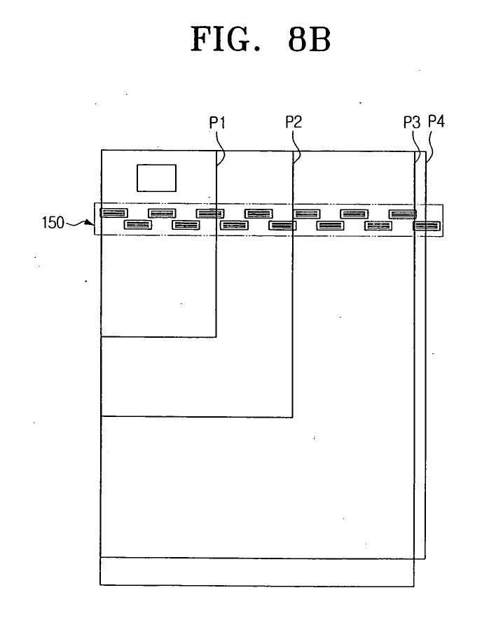

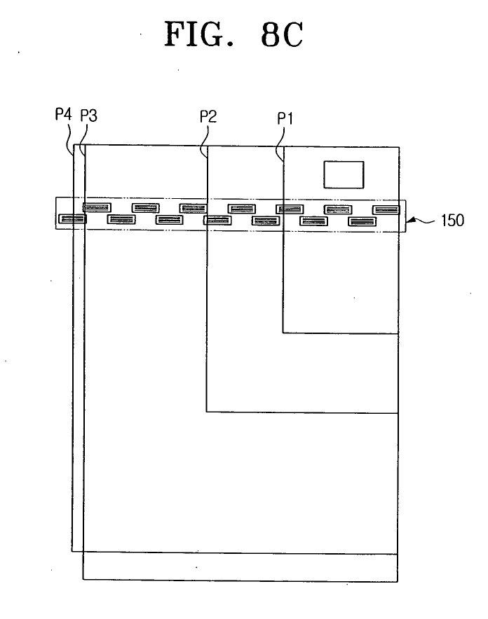

Referring to FIGS. 7 and 8, which illustrate example embodiments of the present general inventive concept, the image forming apparatus is constructed so that the print medium P is displaced in the widthwise direction of the print medium P to permit a change in the relative position between the print medium P and the print head 50. This is unlike the other embodiment of FIGS. 3A and 3B in which the print head 50 is displaced to cause the change in relative position between the print head 50 and the print medium P. Hereinafter, the displacement of the print medium with respect to the print head 50 is described in further detail.

Referring to FIG. 7, a displacement unit 160 includes a screw 161 rotatably supported on a paper-feeding tray 120, a second drive motor 163 to rotationally drive the screw 161, and a power transmission unit 164 having one or more gear trains to transmit the power of the second drive motor 163 to the screw 161.

The screw 161 is installed through a pick-up unit 130 and formed with external threads having a pitch around a circumferential surface of the pick-up unit 130. The pick-up unit 130 has a hole, through which the screw 161 is extended and which has internal threads around an inner circumferential surface, which mesh with the external threads formed around the screw 161. With this arrangement, if the screw 161 is rotated, the pick-up unit 130 is moved left or right along a length direction of the screw 161.

The second drive motor 163 is connected with the controller 70 to communicate signals with the controller 70, and the rotational drive of the second drive motor 163 may be controlled by the signals transmitted from the controller 70.

According to the present embodiment, if the deviation in use frequency of nozzles is larger than the reference deviation, the current reference nozzle group is changed to a new reference nozzle group. However, in the present example embodiment, the change in relative position between the print head 150 and a print medium P on the basis of the reference nozzle group of FIGS. 3A and 3B is different from that of the above-described embodiment of FIG. 5. For example, if the current reference nozzle is changed to the new reference nozzle, the controller 70 drives the second drive motor 163 on the basis of the new reference nozzle. Then, the screw 161 is rotated through the power transmission unit 164 while the pick-up unit 130 is displaced in the widthwise direction of the print medium along the length of the screw 161.

FIGS. 8A to 8C illustrate a positional relationship between the print medium P and the print head 150 according to the displacement of the pick-up unit 130. Referring to FIGS. 8A to 8C, if the pick-up unit 130 is displaced in the widthwise direction of the print medium P, the position of the print medium P loaded on the paper-feeding tray 120 is changed depending on the position of the pick-up unit 130. The position of the loaded print medium P on the paper-feeding tray 120 can be changed by manually or automatically moving a print medium guide member (not shown) provided on the paper-feeding tray 120. Because the movement of the print medium P on the paper-feeding tray 120 is well known in the art, further description of this feature is omitted.

FIG. 8A illustrates a state of the print head 150 and the printing medium P at the time of picking up a central portion of the print medium P, in which P1 indicates an index card-size paper, P2 indicates a photo-size paper, P3 indicates an A4-size paper, and P4 indicates a letter-size paper. In addition, FIGS. 8B and 8C illustrate the relative positions between the print head 150 and the print medium P at the time when the pick-up unit 130 is positioned at the left side and at the time when the pick-up unit 130 is positioned at the right side, respectively.

Displacing the pick-up unit 130 and moving and picking up the print medium P on the paper feeding tray 120, according to the position of the displaced pick-up unit 130, it is possible to cause a change in relative position between the print head 150 and the print medium P. Further, it is also possible to change the relative position between the print head 150 and the print medium P through various techniques well known in the art. It is possible to make the relative position of the print head 150 with respect to the printing medium P according to a type of the printing medium P and/or the use frequency.

As described above, according to the present embodiment, it is possible to reduce deviation in use frequency of respective nozzles by causing a change in relative position between a print head and a print medium. By reducing the deviation in use frequency of nozzles, it is possible to increase the life spans of the nozzles, as a result the life spans of a print head and an image forming apparatus can be increased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a print head having a plurality of nozzles arranged in a widthwise direction of a print medium;
a displacement unit to cause a change in relative position between the print medium and the print head; and
a controller to control the displacement unit to make the change, so that deviation in a use frequency of the respective nozzles is reduced.

2. The image forming apparatus as claimed in claim 1, wherein if the deviation in use frequency of the respective nozzles exceeds a predetermined value, the controller changes a current reference nozzle group of the nozzles to a new reference nozzle group of nozzles and controls the displacement unit so that the new reference nozzle group of nozzles can be used to print an image on a sheet of paper rather than the current reference nozzle group of nozzles.

3. The image forming apparatus as claimed in claim 2, wherein the deviation in use frequency of the plurality of nozzles is calculated on the basis of the number of image-formed print media of respective types.

4. The image forming apparatus as claimed in claim 2, wherein the deviation in use frequency of the plurality of nozzles is calculated on the basis of an amount of the printed images.

5. The image forming apparatus as claimed in claim 1, wherein the displacement unit comprises:
a cam member that contacts the print head; and
a first drive motor to drive the cam member.

6. The image forming apparatus as claimed in claim 5, wherein the displacement unit further comprises an elastic member to move the print head against the cam member.

7. The image forming apparatus as claimed in claim 1, further comprising:
a paper-feeding tray on which the print medium is loaded;
a pick-up unit to pick up the print medium loaded on the paper-feeding tray; and
a transfer unit to transfer the print medium picked up by the pick-up unit toward the print head.

8. The image forming apparatus as claimed in claim 7, wherein the displacement unit displaces at least one of the print head and the print medium picked up by the pick-up unit.

9. The image forming apparatus as claimed in claim 7, wherein the displacement unit comprises a screw rotatably supported on the paper-feeding tray; and
a second drive motor to drive the screw, and
wherein the pick-up unit is connected to the screw such that the pick-up unit is displaced along the length of the screw when the screw rotates.

10. An image forming apparatus, set to be used according to a size of a print medium to form an image using the set nozzles, the image forming apparatus comprising:
a print head having a plurality of nozzles arranged in a widthwise direction of a print medium;
a displacement unit to change a relative position between the print medium and the print head; and
a controller to select one of a current reference nozzle group and a new reference nozzle group of the nozzles to be used by controlling the displacement unit to reduce deviation in use frequency of the plurality of nozzles.

11. The image forming apparatus as claimed in claim 10, wherein the number of the nozzles to be used is determined on the basis of one of the current reference nozzle group and the new reference nozzle group, and the controller selects the nozzles to be used by changing the current reference nozzle group to the new reference nozzle group.

12. A method of printing an image in an image forming apparatus which comprises a print head having a plurality of nozzles arranged in a direction transverse to a direction of transferring a print medium, the method comprising:
comparing inputted deviation and previously set reference deviation of the respective plurality of nozzles; and
changing the respective nozzles to be used when the inputted deviation is larger than the previously set reference deviation.

13. The method as claimed in claim 12, wherein the deviation in use frequency of the plurality of nozzles is calculated on the basis of the number of image-formed print media of respective types.

14. The method as claimed in claim 12, wherein the deviation in use frequency of the plurality of nozzles is calculated on the basis of a printed amount.

15. The method as claimed in claim 12, wherein the comparing of the inputted deviation and the previously set reference deviation of the plurality of nozzles further comprises:
changing a reference nozzle group to a new reference nozzle group; and
changing a relative position between the print head and the print medium on the basis of the new reference nozzle.

16. The method as claimed in claim 15, wherein the changing of the relative position between the print head and the print medium on the basis of the new reference nozzle further comprises:
displacing a position of the print medium with respect to the print head on the basis of the new reference nozzle.

17. The method as claimed in claim 15, wherein the changing of the relative position between the print head and the print medium on the basis of the new reference nozzle further comprises:
displacing a position of the print head with respect to the print medium on the basis of the new reference nozzle.

18. An image forming apparatus comprising:
a print head having a first and second groups of nozzles to be used to form an image on a print medium; and
a controller to control a relative position between the print head and the print medium and to select one of the first and second groups of the nozzles to be used.

19. An image forming apparatus comprising:
a print head having a first nozzle having a first use frequency and a second nozzle having a second use frequency; and
a controller to select one of the first nozzle and the second nozzle to be used to form an image on a print medium according to at least one of the first use frequency and the second use frequency.

20. An image forming apparatus comprising:
a print head having a plurality of nozzles disposed along a widthwise direction of a print medium to form a full line image on the print medium without moving in the widthwise direction; and
a controller to adjust a relative position between the print head and the print medium in the widthwise direction so that one of first and second groups of the plurality of nozzles is disposed to form the full line image on the print medium.
